(19) United States
(12) Patent Application Publication
(10) Pub. No.: US 2017/0337221 A1
(43) Pub. Date: Nov. 23, 2017

(54) FOOTPRINT SEARCH METHOD AND SYSTEM

(71) Applicant: Republic of Korea (National Forensic Service Director Ministry of Public Administration and Sec, Seoul (KR)

(72) Inventors: Nam Kyu Park, Bucheon-si (KR); Jin Pyo Kim, Yuseong-gu (KR); Dong Hwan Kim, Wonju-si (KR); Young Il Seo, Wonju-si (KR); Sang Yoon Lee, Siheung-si (KR)

(21) Appl. No.: 15/411,516

(22) Filed: Jan. 20, 2017

(30) Foreign Application Priority Data
May 3, 2016 (KR) 10-2016-0054639

(51) Int. Cl. G06F 17/30; G06K 9/46; G06K 9/62; H04N 13/02

(52) U.S. Cl. CPC G06F 17/30256; H04N 13/0203; G06K 9/4604; G06K 9/6276

(57) ABSTRACT

Provided is a footprint search method. The footprint search method includes: a footprint image generating operation of generating at least one footprint image from an input image; a partial footprint image classifying operation of classifying the footprint image into one or more partial footprint images having same unit patterns; a feature information acquiring operation of acquiring one or more feature information elements corresponding to the unit pattern of the one or more partial footprint images; a search operation of searching a database for the one or more feature information elements and retrieving a search result record corresponding to one or more items of the one or more feature information elements; and a search result providing operation of providing the search result record to a user.

### CROSS-REFERENCE TO RELATED APPLICATION

This application claims the benefit of Korean Patent Application No. 10-2016-0054639, filed on May 3, 2016, in the Korean Intellectual Property Office, the disclosure of which is incorporated herein in its entirety by reference.

### BACKGROUND

### 1. Field

One or more embodiments relate to footprint search methods and systems.

### 2. Description of the Related Art

Various evidence, such as bloodstains left by a criminal, may remain at a crime scene. The remaining evidence may be collected and analyzed to identify and arrest the criminal based on analysis results, and the analysis results may also be the basis for determining whether a person is guilty or innocent during the trial.

A footprint may refer to a shoe print left by the criminal at the crime scene. The footprint may be analyzed to obtain data such as the type and size of a shoe worn by the criminal, and the footprint may be collected by being attached to a transfer sheet coated with gelatin.

In the related art, it may be very inconvenient searching for a corresponding footprint by contrasting the collected footprint and the footprints of other shoes one by one in order to obtain a meaningful conclusion from the collected footprint.

### SUMMARY

One or more embodiments include methods and systems that may extract a footprint from an image, extract feature information from the extracted footprint, and search a database for a shoe including a feature matching the footprint.

One or more embodiments include methods for constructing a shoe database including three-dimensional (3D) images of shoes.

One or more embodiments include methods and systems that may provide more detailed information about a footprint by providing a 3D image of a shoe as a search result.

Additional aspects will be set forth in part in the description which follows and, in part, will be apparent from the description, or may be learned by practice of the presented embodiments.

According to one or more embodiments, a footprint search method includes: a footprint image generating operation of generating at least one footprint image from an input image; a partial footprint image classifying operation of classifying the footprint image into one or more partial footprint images having same unit patterns; a feature information acquiring operation of acquiring one or more feature information elements corresponding to the unit pattern of the one or more partial footprint images; a search operation of searching a database for the one or more feature information elements and retrieving a search result record corresponding to one or more items of the one or more feature information elements; and a search result providing operation of providing the search result record to a user.

The partial footprint image classifying operation may include classifying the footprint image into a first partial footprint image corresponding to a front heel and a second partial footprint image corresponding to a back heel.

The feature information acquiring operation may include acquiring a first keyword and a second keyword corresponding to the respective unit patterns of the first partial footprint image and the second partial footprint image; and the search operation may include retrieving one or more records including the first keyword as a field value corresponding to the first partial footprint image and the second keyword as a field value corresponding to the second partial footprint image.

The feature information acquiring operation may include acquiring a first unit pattern image and a second unit pattern image corresponding to the respective unit patterns of the first partial footprint image and the second partial footprint image; and the search operation may include retrieving one or more records including the first unit pattern image as a field value corresponding to the first partial footprint image and the second unit pattern image as a field value corresponding to the second partial footprint image.

The partial footprint image classifying operation may include further classifying a trademark image corresponding to a trademark from the footprint image; the feature information acquiring operation may include acquiring a trademark name corresponding to the trademark image; and the search operation may include retrieving one or more records including the trademark name as a field value of the trademark.

The footprint search method may further include a shoe registering operation of registering information about one or more shoes in the database, wherein the shoe registering operation may include: a bottom surface image generating operation of generating a bottom surface image of the shoe from a three-dimensional (3D) input image; a partial bottom surface image classifying operation of classifying the bottom surface image into one or more partial bottom surface images having same unit patterns; a bottom surface feature information acquiring operation of acquiring one or more bottom surface feature information elements corresponding to the unit pattern of the one or more partial bottom surface images; and a record generating operation of generating a record about the shoe including the one or more bottom surface feature information elements, the bottom surface image, and the 3D input image in the database.

The search result providing operation may include displaying a 3D image included in the search result record on a display device.

The partial footprint image classifying operation may include classifying the entire footprint image as a partial footprint image; the feature information acquiring operation may include acquiring the entire footprint image as one feature information element; and the search operation may include searching the database for the entire footprint image and retrieving one or more corresponding search result records.

According to one or more embodiments, a footprint search system includes: an image acquiring device configured to image a footprint to generate one or more input images; a three-dimensional (3D) image acquiring device configured to image a sample shoe in a 3D shape to generate one or more 3D input images; and a footprint search device configured to generate a footprint image from the input image generated by the image acquiring device, classify the footprint image into one or more partial footprint images having same unit patterns, acquire one or more feature information elements corresponding to the unit pattern of the one or more partial footprint images, search a database for the one or more feature information elements and retrieve a search result record corresponding to one or more items of the one or more feature information elements, and provide the search result record to a user.

The footprint search device may be further configured to generate a bottom surface image of the shoe from the 3D input image generated by the 3D image acquiring device, classify the bottom surface image into one or more partial bottom surface images having same unit patterns, acquire one or more bottom surface feature information elements corresponding to the unit pattern of the one or more partial bottom surface images, and generate a record about the shoe including the one or more bottom surface feature information elements, the bottom surface image, and the 3D input image in the database.

### BRIEF DESCRIPTION OF THE DRAWINGS

These and/or other aspects will become apparent and more readily appreciated from the following description of the embodiments, taken in conjunction with the accompanying drawings in which:

FIG. 1 schematically illustrates a footprint search system according to an embodiment;

FIG. 2 illustrates an example of an input image acquired by an image acquiring device;

FIG. 3 illustrates an example of a footprint image generated by a footprint image generating unit;

FIG. 4 schematically illustrates a footprint search process according to an embodiment; and

FIG. 5 illustrates an example of a search result screen provided by a search result providing unit according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

The inventive concept may include various embodiments and modifications, and certain embodiments thereof are illustrated in the drawings and will be described herein in detail. The effects and features of the inventive concept and the accomplishing methods thereof will become apparent from the following description of the embodiments, taken in conjunction with the accompanying drawings. However, the inventive concept is not limited to the embodiments described below, and may be embodied in various modes.

Hereinafter, embodiments of the inventive concept will be described in detail with reference to the accompanying drawings. In the following description, like reference numerals will denote like elements, and redundant descriptions thereof will be omitted.

It will be understood that although the terms “first”, “second”, etc. may be used herein to describe various components, these components should not be limited by these terms. These terms are only used to distinguish one component from another.

As used herein, the singular forms “a”, “an”, and “the” are intended to include the plural forms as well, unless the context clearly indicates otherwise.

It will be further understood that the terms “comprise”, “include”, and “have” used herein specify the presence of stated features or components, but do not preclude the presence or addition of one or more other features or components.

It will be understood that when a layer, region, or component is referred to as being “formed on” another layer, region, or component, it may be directly or indirectly formed on the other layer, region, or component. That is, for example, intervening layers, regions, or components may be present.

Sizes of components in the drawings may be exaggerated for convenience of description. In other words, since sizes and thicknesses of components in the drawings are arbitrarily illustrated for convenience of description, the following embodiments are not limited thereto.

When a certain embodiment may be implemented differently, a specific process order may be performed differently from the described order. For example, two consecutively described processes may be performed substantially at the same time or performed in an order opposite to the described order.

It will be understood that when a layer, region, or component is referred to as being “connected to” another layer, region, or component, it may be directly connected to the other layer, region, or component or may be indirectly connected to the other layer, region, or component with one or more intervening layers, regions, or components interposed therebetween. For example, it will be understood that when a layer, region, or component is referred to as being “electrically connected to” another layer, region, or component, it may be directly electrically connected to the other layer, region, or component or may be indirectly electrically connected to the other layer, region, or component with one or more intervening layers, regions, or components interposed therebetween.

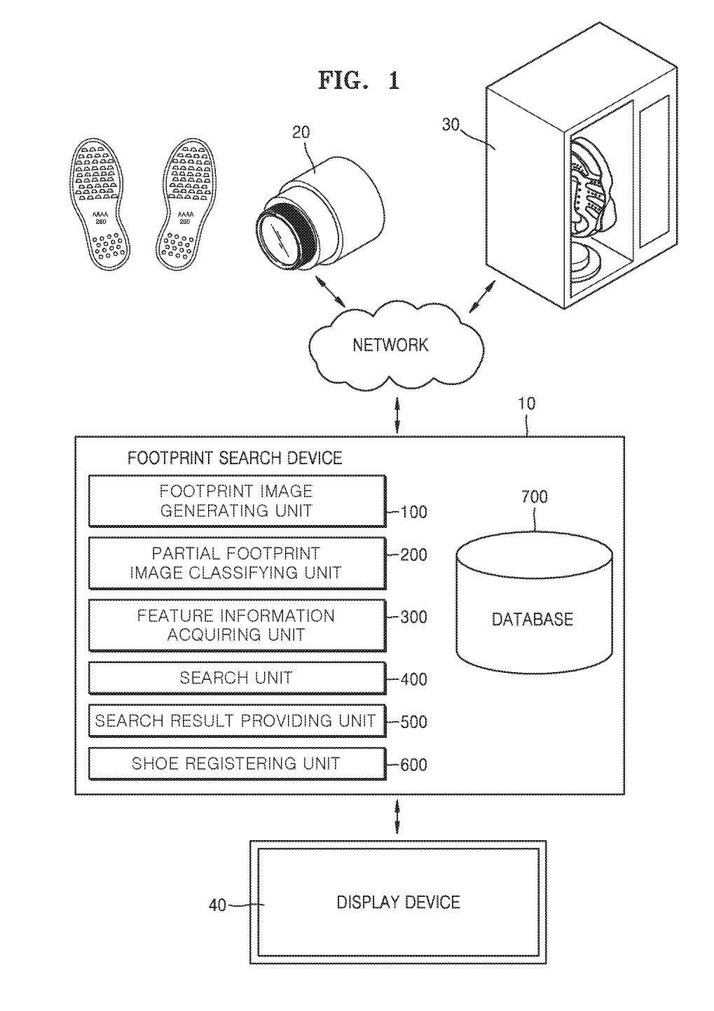

FIG. 1 schematically illustrates a footprint search system according to an embodiment.

Referring to FIG. 1, the footprint search system according to an embodiment may include a footprint search device 10, an image acquiring device 20, a three-dimensional (3D) image acquiring device 30, and a display device 40.

According to an embodiment, the image acquiring device 20 may be a camera including a lens and an image sensor. The lens may be a lens group including one or more lenses. The image sensor may convert an image, which is input by the lens, into an electrical signal. For example, the image sensor may be a semiconductor device such as a charge-coupled device (CCD) or a complementary metal oxide semiconductor (CMOS) that may convert an optical signal into an electrical signal. For example, the image acquiring device 20 may be a camera that provides a black-and-white image, a red/green/blue (RGB) image of a space or a surface including a footprint, or a distance image including distance information.

The image acquiring device 20 may transmit an acquired image to the footprint search device 10 through a network. For example, when the image acquiring device 20 is directly connected to the footprint search device 10, the image acquiring device 20 may transmit the acquired image to the footprint search device 10 according to a universal standard such as Universal Serial Bus (USB).

According to an embodiment, the 3D image acquiring device 30 may refer to a device that may acquire the 3D shape of an object by extracting the coordinate values of the outline of the object. For example, the 3D image acquiring device 30 may be a contactless image acquiring device that determines a 3D shape of a scan target object by collecting the light reflected or scattered from the scan target object and performing signal processing or calculating the distance from each measurement part. As another example, the 3D image acquiring device 30 may be a contact image acquiring device that uses one or more contact bars contacting the surface of a scan target object. However, the contact image acquiring device and the contactless image acquiring device are merely examples; and the inventive concept is not limited thereto and the 3D image acquiring device 30 may be any device that may acquire the shape of the outline of an object.

According to an embodiment, the display device 40 may refer to a display device that displays figures, characters, or any combination thereof according to the electrical signal generated by the footprint search device 10. For example, the display device 40 may include any one of a cathode ray tube (CRT), a liquid crystal display (LCD), a plasma display panel (PDP), and an organic light-emitting diode (OLED); however, the inventive concept is not limited thereto.

The display device 40 and the footprint search device 10 may be connected through the network. Although FIG. 1 illustrates that the display device 40 is directly connected to the footprint search device 10, the display device 40 may receive image data from the footprint search device 10 through the network.

One or more display devices 40 may be provided according to the system configurations. For example, when a plurality of display devices 40 are provided, the maximum possible image resolutions or the screen sizes of the respective display devices 40 may be different from each other.

Also, the network described herein may be, for example, but is not limited to, a wireless network, a wired network, a public network such as the Internet, a private network, a Global System for Mobile communications (GSM) network, a General Packet Radio Service (GPRS) network, Local Area Network (LAN), Wide Area Network (WAN), Metropolitan Area Network (MAN), a cellular network, Public Switched Telephone Network (PSTN), Personal Area Network (PAN), Bluetooth, Wi-Fi Direct (WFD), Near Field Communication (NFC), Ultra Wide Band (UWB), any combination thereof, or any other network.

According to an embodiment, the footprint search device 10 may include a footprint image generating unit 100, a partial footprint image classifying unit 200, a feature information acquiring unit 300, a search unit 400, a search result providing unit 500, a shoe registering unit 600, and a database 700. The footprint image generating unit 100 may generate at least one footprint image from the input image acquired by the image acquiring device 20. The partial footprint image classifying unit 200 may classify the footprint image generated by the footprint image generating unit 100 into one or more partial footprint images having the same unit patterns. The feature information acquiring unit 300 may acquire one or more feature information elements corresponding to the unit pattern of the partial footprint image classified by the partial footprint image classifying unit 200. The search unit 400 may search the database 700 for the one or more feature information elements acquired by the feature information acquiring unit 300 and retrieve a search result record corresponding to one or more items of the one or more feature information elements. The search result providing unit 500 may provide the search result record to a user. The shoe registering unit 600 may register information about one or more shoes in the database 700.

However, the above classification of the footprint image generating unit 100, the partial footprint image classifying unit 200, the feature information acquiring unit 300, the search unit 400, the search result providing unit 500, and the shoe registering unit 600 are merely functional classifications for convenience; and the respective components may not be physically clearly divided from each other, the functions performed by the respective components may be performed in a mutually overlapping manner, and some components may be omitted and/or included in other components. For example, the search unit 400 and the search result providing unit 500 may be configured as an integrated search unit.

According to an embodiment, the footprint search device 10 may correspond to or include one or more processors. Accordingly, the footprint search device 10 may be driven while being included in a hardware device such as a microprocessor or a general-purpose computer system.

According to an embodiment, the footprint image generating unit 100 may generate at least one footprint image from the input image acquired by the image acquiring device 20.

Herein, the input image may be an image of a space or a surface including a footprint. For example, the image acquiring device 20 may acquire the input image by photographing the footprint attached to a transfer sheet. In this case, the input image may be acquired by photographing the shoe print left in the scene and then attached to the transfer sheet. Also, the input image may be acquired by photographing the shoe print left in the scene, that is, the footprint itself. In this case, the image acquiring device 20 may acquire the input image by photographing the scene itself. However, this is merely an example; and the inventive concept is not limited thereto and the input image may be any image including the footprint, regardless of the acquisition method thereof.

For example, in addition to the footprint, the input image may include a bottom, a wall surface, and a vehicle wheel print around the footprint. Thus, herein, the footprint image may be obtained by extracting only the observation target footprint from the above input image.

In this case, for easier footprint observation, the footprint image may be obtained by extracting the footprint from the input image and performing one or more of image rotation, black-and-white (grayscale) processing, contour extraction processing, sharpening, tilt (inclination) processing, engrave-emboss conversion, and bilateral (horizontal) symmetry processing thereon.

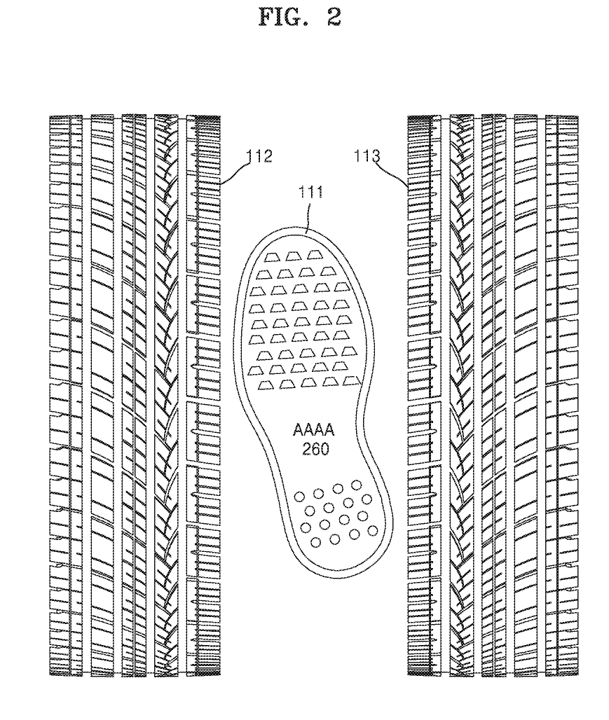

FIG. 2 illustrates an example of an input image acquired by the image acquiring device 20. As described above, the input image may further include vehicle wheel prints 112 and 113 in addition to a footprint 111.

The footprint image generating unit 100 may generate a footprint image including only the footprint 111 from the input image. Thus, the footprint image generating unit 100 may generate the footprint image that does not include portions other than the footprint 111, such as the vehicle wheel prints 112 and 113. In this case, for easier footprint observation, the footprint image generating unit 100 may extract the footprint from the input image and perform one or more of image rotation, black-and-white (grayscale) processing, contour extraction processing, sharpening processing, tilt (inclination) processing, engrave-emboss conversion, and bilateral (horizontal) symmetry processing thereon.

Also, when the input image includes a plurality of footprints, the footprint image generating unit 100 may detect a footprint image including only one of the plurality of footprints. In this case, after completion of searching for the footprint image including the one footprint, the footprint image generating unit 100 may search for a footprint image of another footprint among the other footprints.

Accordingly, the inventive concept may conveniently use various images including footprints as the input image even without performing separate preprocessing.

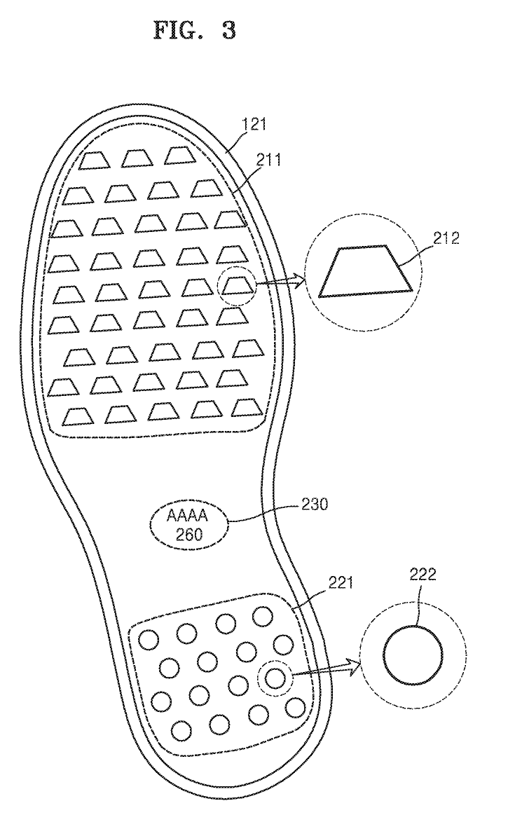

FIG. 3 illustrates an example of a footprint image 121 generated by the footprint image generating unit 100. In comparison with the above input image (see FIG. 2), the footprint image 121 does not include items other than the footprint (e.g., vehicle wheel prints).

Hereinafter, for convenience of description, it is assumed that the footprint search device 10 according to an embodiment detects the footprint image 121 illustrated in FIG. 3; however, the inventive concept is not limited thereto.

According to an embodiment, the partial footprint image classifying unit 200 may classify the footprint image generated by the footprint image generating unit 100 into one or more partial footprint images having the same unit patterns.

Herein, “classifying an image A into one or more images B” may refer to dividing each portion of an image A into several images B according to a certain criterion. For example, “classifying an image A into one or more images B” may refer to dividing an image A into images B1, B2, and B3 that are images of different portions.

Herein, the unit pattern may refer to the most basic unit of a certain region. Thus, the partial footprint image may refer to a partial region of the footprint image, as a certain region including the same basic shapes.

For example, when a front heel of a shoe includes a plurality of diamond projections and a back heel thereof includes a plurality of circular projections, the partial footprint image classifying unit 200 may classify a footprint image of the shoe into a partial footprint image corresponding to the front heel including diamond shapes and a partial footprint image corresponding to the back heel including circular shapes.

Referring to FIG. 3, the partial footprint image classifying unit 200 may classify the footprint image 121 into a first partial footprint image 211 corresponding to the front heel and a second partial footprint image 221 corresponding to the back heel. In this case, the first partial footprint image 211 may have a diamond shape 212 as a unit pattern, and the second partial footprint image 221 may have a circular shape 222 as a unit pattern.

Also, the partial footprint image classifying unit 200 may classify a trademark image 230 corresponding to the other region from the footprint image 121, in addition to the partial footprint images corresponding to the front heel and/or the back heel. For example, the partial footprint image classifying unit 200 may further classify a trademark image corresponding to a trademark and/or a size. The classified trademark image may provide the manufacturer and/or size information of the shoe corresponding to the footprint image 121 in the feature information acquiring unit 300, as described below.

According to an embodiment, the feature information acquiring unit 300 may acquire one or more feature information elements corresponding to the unit pattern of the one or more partial footprint images classified by the partial footprint image classifying unit 200.

Herein, the expression “acquiring information D corresponding to a unit pattern C” may refer to acquiring a keyword D describing a pattern C that is a unit pattern. In this case, the feature information acquiring unit 300 may acquire text-type data (keyword D) from image-type data (unit pattern C) by using various known techniques for recognizing and interpreting an object in an image. For example, as described above, when “C” is a diamond shape, “D” may be a keyword such as “diamond shape”.

Also, the expression “acquiring information D corresponding to a unit pattern C” may refer to acquiring an image D of a pattern C that is a unit pattern. In this case, “D” may be an image describing a unit pattern such as “212” of FIG. 3.

However, the above keyword and image are merely examples; and the inventive concept is not limited thereto and “D” may be any information corresponding to “C”.

As an example, it is assumed that the partial footprint image classifying unit 200 classifies the footprint image 121 into the first partial footprint image 211 corresponding to the front heel and the second partial footprint image 221 corresponding to the back heel, the first partial footprint image 211 has the diamond shape 212 as the unit pattern, and the second partial footprint image 221 has the circular shape 222 as the unit pattern.

In this case, the feature information acquiring unit 300 may acquire a first keyword corresponding to the diamond shape that is the unit pattern of the first partial footprint image 211 and a second keyword corresponding to the circular shape that is the unit pattern of the second partial footprint image 221. In this case, the first keyword may be “diamond shape” and the second keyword may be “circular shape”.

As another example, the feature information acquiring unit 300 may provide the unit pattern of the first partial footprint image 211 and the unit pattern of the second partial footprint image 221 to the user and acquire the first keyword and the second keyword corresponding thereto from user inputs. In the above example, the feature information acquiring unit 300 acquires the keyword by analyzing the image of the unit pattern of each partial footprint image. However, in the present example, the feature information acquiring unit 300 receives an input of the keyword corresponding to the image of the unit pattern from the user, thus enabling more accurate keyword acquisition.

Also, as another example, the feature information acquiring unit 300 may acquire a first unit pattern image and a second unit pattern image corresponding to the respective unit patterns of the first partial footprint image 211 and the second partial footprint image 221. In this case, the first unit pattern image may be an image including the diamond shape 212, and the second unit pattern image may be an image including the circular shape 222. In the above two examples, the feature information acquiring unit 300 may acquire the “text” corresponding to the unit pattern. However, in the present example, the feature information acquiring unit 300 may acquire the “image” corresponding to the unit pattern.

Also, according to an embodiment, the feature information acquiring unit 300 may acquire a trademark name corresponding to the trademark image 230. As described above, the partial footprint image classifying unit 200 may further classify the trademark image 230 corresponding to the trademark and/or the size. The feature information acquiring unit 300 may acquire information about the trademark and/or the size from the trademark image 230. For example, the feature information acquiring unit 300 may acquire text-type information about the trademark and/or the size from the trademark image 230 by an optical character recognition (OCR) method. In this case, the item to which the acquired text information relates may be classified with reference to a trademark database and/or a size database prestored in the database 700.

Accordingly, the inventive concept may classify the footprint into one or more regions based on the features and extract the feature of each region, thus enabling a more accurate footprint (shoe) search.

According to an embodiment, the search unit 400 may search the database 700 for the one or more feature information elements acquired by the feature information acquiring unit 300 and retrieve a search result record corresponding to one or more items of the one or more feature information elements.

For example, when the feature information acquiring unit 300 acquires text-type feature information about a particular field, such as the first keyword corresponding to the unit pattern of the first partial footprint image 211 or the second keyword corresponding to the unit pattern of the second partial footprint image 221, the search unit 400 may retrieve one or more records matching the field and the text of the acquired information.

Herein, the term ‘record’ may refer to a data set generated for each shoe, and the term ‘field’ may be an item constituting the data set. For example, the record may be a data set for a shoe A, and the field may be a front heel unit pattern shape, a front heel unit pattern number, a front heel unit pattern image, a back heel unit pattern shape, a back heel unit pattern number, a back heel unit pattern image, a manufacturer, and/or a size.

Thus, when the feature information acquiring unit 300 acquires the first keyword and the second keyword corresponding to the respective unit patterns of the first partial footprint image and the second partial footprint image, the search unit 400 may retrieve one or more records including the first keyword as the field value corresponding to the first partial footprint image and the second keyword as the field value corresponding to the second partial footprint image.

Also, when the feature information acquiring unit 300 acquires the trademark name corresponding to the trademark image, the search unit 400 may retrieve one or more records including the trademark name as the field value of the trademark.

Also, when the feature information acquiring unit 300 acquires image-type feature information about a particular field, such as the first unit pattern image corresponding to the unit pattern of the first partial footprint image 211 or the second unit pattern image corresponding to the unit pattern of the second partial footprint image 221, the search unit 400 may retrieve one or more records matching the field and the image of the acquired information. In this case, the search unit 400 may retrieve the record by comparing the unit pattern image and the image stored in the database 700 by using various known techniques for determining the similarity between two images.

For example, when the feature information acquiring unit 300 acquires the first unit pattern image and the second unit pattern image corresponding to the respective unit patterns of the first partial footprint image 211 and the second partial footprint image 221, the search unit 400 may retrieve one or more records including the first unit pattern image as the field value corresponding to the first partial footprint image 211 and the second unit pattern image as the field value corresponding to the second partial footprint image 221.

According to an embodiment, the shoe registering unit 600 may register information about one or more shoes in the database 700.

The shoe registering unit 600 may generate a bottom surface image of a registration target shoe from a 3D input image acquired by the 3D image acquiring device 30. Since the 3D input image includes images in all directions such as the side, front, and top surfaces including the bottom surface of the shoe, the shoe registering unit 600 may generate the bottom surface image by extracting the bottom surface image from the 3D input image.

The shoe registering unit 600 may classify the generated bottom surface image into one or more partial bottom surface images having the same unit patterns and acquire one or more bottom surface feature information elements corresponding to the unit pattern of the one or more partial bottom surface images. Since the shoe registering unit 600 classifying the bottom surface image into partial bottom surface images and acquiring the feature information from the classified partial bottom surface image may be easily derived from the partial footprint image classifying unit 200 and the feature information acquiring unit 300 described above, detailed descriptions thereof will be omitted herein for conciseness.

The shoe registering unit 600 may generate a record about the shoe including the one or more bottom surface feature information elements, the bottom surface image, and the 3D input image in the database 700. Thus, the shoe registering unit 600 may include a 3D input image, a bottom surface image, and bottom surface feature information in generating a record about a particular shoe. In this case, it may be apparent that additional information may be input and received from the user and then added to the record.

According to another embodiment, the footprint search device 10 may search the database 700 for the entire footprint image 121 and retrieve one or more corresponding records. In detail, according to another embodiment, the partial footprint image classifying unit 200 may classify the entire footprint image 121 as a partial footprint image, and the feature information acquiring unit 300 may acquire the entire footprint image 121 as one feature information element. In addition, the search unit 400 may search the database 700 for the footprint image 121 and retrieve one or more corresponding search result records. Accordingly, the present embodiment may retrieve one or more search result records matching the bottom surface image of the footprint image 121.

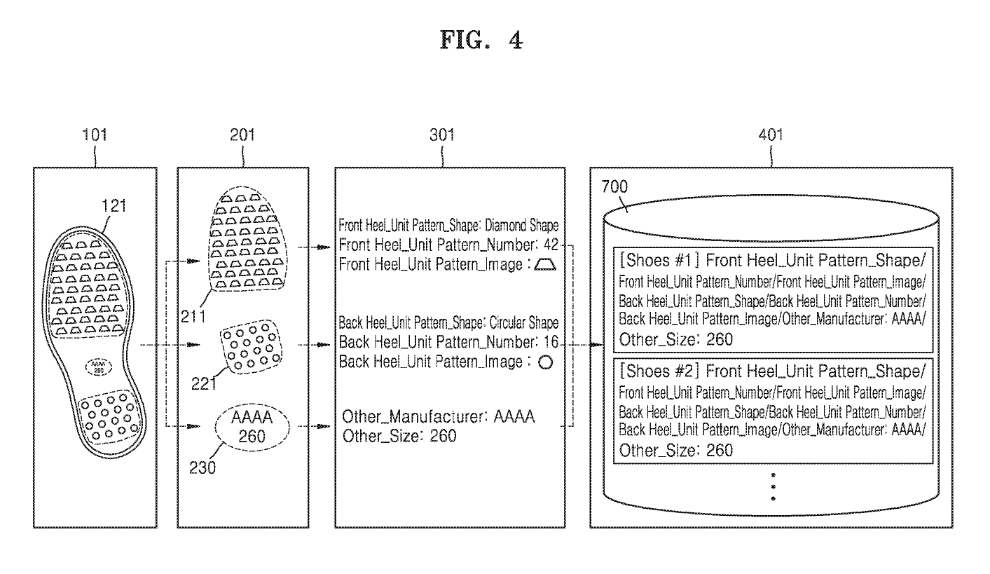

FIG. 4 schematically illustrates a footprint search process according to an embodiment. Hereinafter, redundant descriptions overlapping with those described in FIGS. 1 to 3 will be omitted for conciseness.

Referring to FIG. 4, the footprint image generating unit 100 may generate at least one footprint image 121 from the input image acquired by the image acquiring device 20 (in operation 101). As described above, since the input image may include various information in addition to the footprint, the footprint image generating unit 100 may generate the footprint image 121 by extracting only the observation target footprint from the input image and performing one or more of image rotation, black-and-white (grayscale) processing, contour extraction processing, sharpening, tilt (inclination) processing, engrave-emboss conversion processing, and bilateral (horizontal) symmetry processing thereon.

The partial footprint image classifying unit 200 may classify the footprint image generated by the footprint image generating unit 100 into one or more partial footprint images having the same unit patterns (in operation 201). For example, the partial footprint image classifying unit 200 may classify the footprint image 121 into the first partial footprint image 211 corresponding to the front heel, the second partial footprint image 221 corresponding to the back heel, and the trademark image 230 corresponding to the trademark.

The feature information acquiring unit 300 may acquire one or more feature information elements corresponding to the unit pattern of the partial footprint image classified by the partial footprint image classifying unit 200 (in operation 301). For example, the feature information acquiring unit 300 may acquire the first unit pattern image, the unit pattern number “42”, and the first keyword “diamond shape” corresponding to the diamond shape that is the unit pattern of the first partial footprint image 211. Also, the feature information acquiring unit 300 may acquire information such as a manufacturer “AAAA” and a size “260” from the trademark image 230. In this case, with reference to the trademark database and/or the size database prestored in the database 700, the feature information acquiring unit 300 may determine which field the acquired text information belongs to.

The search unit 400 may search the database 700 for the one or more feature information elements acquired by the feature information acquiring unit 300 and retrieve a search result record corresponding to one or more items of the one or more feature information elements (in operation 401).

For example, when the feature information acquiring unit 300 acquires text-type feature information about a particular field, such as the first keyword corresponding to the unit pattern of the first partial footprint image 211 or the second keyword corresponding to the unit pattern of the second partial footprint image 221, the search unit 400 may retrieve one or more records matching the field and the text thereof.

Also, when the feature information acquiring unit 300 acquires image-type feature information about a particular field, such as the first unit pattern image corresponding to the unit pattern of the first partial footprint image 211 or the second unit pattern image corresponding to the unit pattern of the second partial footprint image 221, the search unit 400 may retrieve one or more records matching the field and the image thereof. In this case, the search unit 400 may retrieve the record by comparing the unit pattern image and the image stored in the database 700 by using various known techniques for determining the similarity between two images.

According to an embodiment, the search result providing unit 500 may provide the search result record to the user.

Herein, “providing to the user” may refer to displaying the desired content on the screen through the display device 40. Thus, “providing the search result record to the user” may refer to displaying a search result screen on the display device 40.

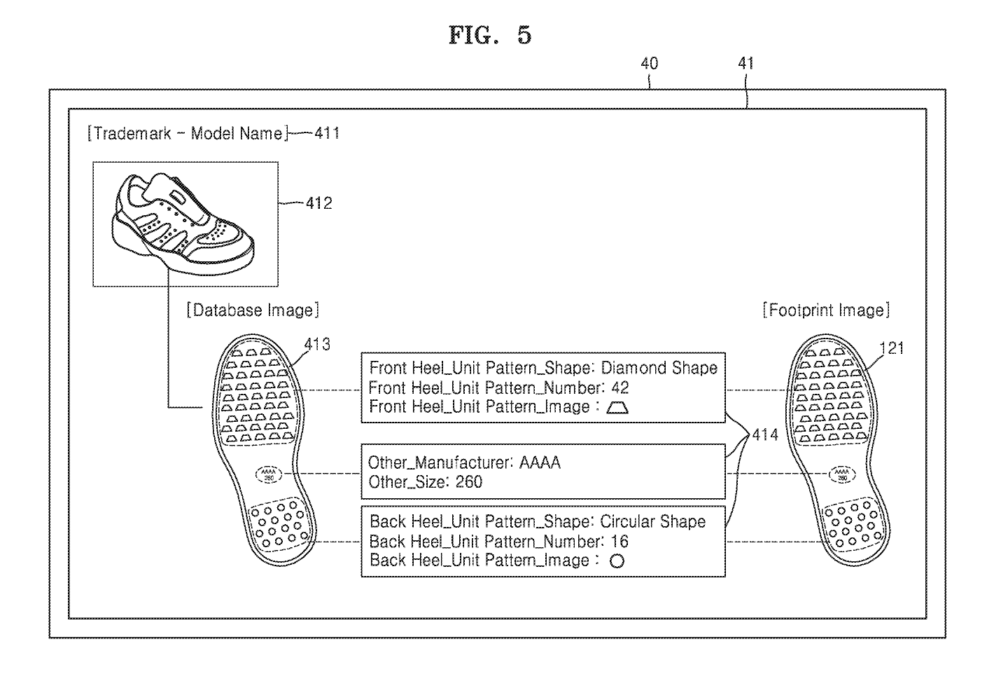

FIG. 5 illustrates an example of a search result screen provided by the search result providing unit 500 according to an embodiment.

A screen 41 of FIG. 5 may be displayed on the display device 40 and may include one or more information elements included in the search result record. For example, the screen 41 may include a trademark, a model name 411, and a 3D image 412 of the shoe included in the search result record. Also, the screen 41 may include the footprint image 121 and a shoe bottom surface image 413 acquired from the 3D image. In this case, the screen 41 may further include a contrast table 414 for contrasting the shoe bottom surface image 413 and the footprint image 121.

The footprint search methods according to the embodiments of the inventive concept may also be embodied as computer-readable codes on a computer-readable recording medium. The computer-readable recording medium may include any data storage device that may store data which may be thereafter read by a computer system. Examples of the computer-readable recording medium may include read-only memories (ROMs), random-access memories (RAMs), compact disk read-only memories (CD-ROMs), magnetic tapes, floppy disks, and optical data storage devices. The computer-readable recording medium may also be distributed over network-coupled computer systems so that the computer-readable codes may be stored and executed in a distributed fashion. Also, functional programs, codes, and code segments for accomplishing the inventive concept may be easily construed by programmers skilled in the art to which the inventive concept pertains.

As described above, according to the embodiments, it is possible to implement methods and systems that may extract a footprint from an image, extract feature information from the extracted footprint, and search a database for a shoe including a feature matching the footprint.

Also, according to the embodiments, it is possible to construct a shoe database including 3D images of shoes.

Also, according to the embodiments, it is possible to make a significant contribution to an investigation by providing more detailed information about a footprint by providing a 3D image of a shoe as a search result.

It should be understood that embodiments described herein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope of the inventive concept as defined by the following claims.

It should be understood that embodiments described herein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope of the inventive concept as defined by the following claims.

What is claimed is:

1. A footprint search method comprising:
a footprint image generating operation of generating at least one footprint image from an input image;
a partial footprint image classifying operation of classifying the footprint image into one or more partial footprint images having same unit patterns;
a feature information acquiring operation of acquiring one or more feature information elements corresponding to the unit pattern of the one or more partial footprint images;
a search operation of searching a database for the one or more feature information elements and retrieving a search result record corresponding to one or more items of the one or more feature information elements; and
a search result providing operation of providing the search result record to a user.

2. The footprint search method of claim 1, wherein the partial footprint image classifying operation comprises classifying the footprint image into a first partial footprint image corresponding to a front heel and a second partial footprint image corresponding to a back heel.

3. The footprint search method of claim 2, wherein
the feature information acquiring operation comprises acquiring a first keyword and a second keyword corresponding to the respective unit patterns of the first partial footprint image and the second partial footprint image; and
the search operation comprises retrieving one or more records comprising the first keyword as a field value corresponding to the first partial footprint image and the second keyword as a field value corresponding to the second partial footprint image.

4. The footprint search method of claim 2, wherein
the feature information acquiring operation comprises acquiring a first unit pattern image and a second unit pattern image corresponding to the respective unit patterns of the first partial footprint image and the second partial footprint image; and
the search operation comprises retrieving one or more records comprising the first unit pattern image as a field value corresponding to the first partial footprint image and the second unit pattern image as a field value corresponding to the second partial footprint image.

5. The footprint search method of claim 2, wherein
the partial footprint image classifying operation comprises further classifying a trademark image corresponding to a trademark from the footprint image;
the feature information acquiring operation comprises acquiring a trademark name corresponding to the trademark image; and
the search operation comprises retrieving one or more records comprising the trademark name as a field value of the trademark.

6. The footprint search method of claim 1, further comprising a shoe registering operation of registering information about one or more shoes in the database,
wherein the shoe registering operation comprises:
a bottom surface image generating operation of generating a bottom surface image of the shoe from a three-dimensional (3D) input image;
a partial bottom surface image classifying operation of classifying the bottom surface image into one or more partial bottom surface images having same unit patterns;
a bottom surface feature information acquiring operation of acquiring one or more bottom surface feature information elements corresponding to the unit pattern of the one or more partial bottom surface images; and
a record generating operation of generating a record about the shoe comprising the one or more bottom surface feature information elements, the bottom surface image, and the 3D input image in the database.

7. The footprint search method of claim 1, wherein the search result providing operation comprises displaying a 3D image included in the search result record on a display device.

8. The footprint search method of claim 1, wherein
the partial footprint image classifying operation comprises classifying the entire footprint image as a partial footprint image;
the feature information acquiring operation comprises acquiring the entire footprint image as one feature information element; and
the search operation comprises searching the database for the entire footprint image and retrieving one or more corresponding search result records.

9. A footprint search system comprising:
an image acquiring device configured to image a footprint to generate one or more input images;
a three-dimensional (3D) image acquiring device configured to image a sample shoe in a 3D shape to generate one or more 3D input images; and
a footprint search device configured to generate a footprint image from the input image generated by the image acquiring device, classify the footprint image into one or more partial footprint images having same unit patterns, acquire one or more feature information elements corresponding to the unit pattern of the one or more partial footprint images, search a database for the one or more feature information elements and retrieve a search result record corresponding to one or more items of the one or more feature information elements, and provide the search result record to a user.

10. The footprint search system of claim 9, wherein the footprint search device is further configured to generate a bottom surface image of the shoe from the 3D input image generated by the 3D image acquiring device, classify the bottom surface image into one or more partial bottom surface images having same unit patterns, acquire one or more bottom surface feature information elements corresponding to the unit pattern of the one or more partial bottom surface images, and generate a record about the shoe comprising the one or more bottom surface feature information elements, the bottom surface image, and the 3D input image in the database.
